(19) United States
(12) Patent Application Publication
(10) Pub. No.: US 2014/0108098 A1
(43) Pub. Date: Apr. 17, 2014

(54) SYSTEM AND METHOD FOR OPTIMIZING ENTITLEMENTS OF DIGITAL ASSETS

(71) Applicant: DELL PRODUCTS L.P., Round Rock, TX (US)

(72) Inventors: Michael Haze, Round Rock, TX (US); Clint H. O'Connor, Austin, TX (US); Todd Nix, Austin, TX (US)

(73) Assignee: DELL PRODUCTS L.P., Round Rock, TX (US)

(21) Appl. No.: 13/652,618

(22) Filed: Oct. 16, 2012

(51) Int. Cl. G06Q 10/06

(52) U.S. Cl. CPC G06Q 10/0637
USPC 705/7.36

(57) ABSTRACT

In accordance with embodiments of the present disclosure, an information handling system for managing the entitlement of digital assets may include a storage medium and a processor. The processor may be configured to receive digital asset usage information regarding usage of a digital asset within an enterprise. The processor may also be configured to receive entitlement information regarding existing entitlements for usage of the digital asset within the enterprise. The processor may further configured to receive available entitlement information regarding entitlements other than the existing entitlements that may be acquired for usage of the digital asset within the enterprise. The processor may additionally be configured to determine based on a comparison of the digital asset usage information to the available entitlement information, whether acquisition of entitlements other than the existing entitlements is more cost efficient.

### TECHNICAL FIELD

The present disclosure relates to the management of information handling systems. More specifically, embodiments of the disclosure provide a system, method, and article of manufacture for optimizing entitlements of digital assets.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Current approaches to acquiring digital assets online, whether in physical or digital form, typically involve the purchaser placing an order with an online retailer and then concluding the purchase with a payment transaction. If the digital assets are in physical form, they are then shipped to the purchaser. If in digital form, the purchaser typically conducts a download session, which may include a unique license key. Known approaches to managing the licensing of downloaded digital assets include establishing a license for a digital asset and a corresponding download link such that it can be sent to a particular information handling system. The license is then associated with the target system and tracked over time for termination, renewal, or possible transfer to another system.

However, the digital assets may be acquired from multiple online sources, including a closed enterprise networking environment, catalog vendors stocking a wide variety of digital assets, or individual software producers. As a result, the purchaser must keep track of the source for each individual digital asset and its associated license.

Furthermore, it is not uncommon for users to misplace or forget their user IDs and passwords. While methods exist to recover a log-in name and password, the process is inherently cumbersome and may create delays in installing the digital assets on the user's system. In view of the foregoing, there is a need for allowing a broad range of digital assets to be delivered digitally, through multiple channels, to multiple information handling systems, through individual or multiple accounts, and to accommodate various licensing restrictions.

In enterprises, digital assets including software are often licensed in a volume license or enterprise agreement and accurate measurements of software usage are required to satisfy license audits. Due to the vast nature of many enterprise computing architectures, such measurements are often difficult. For enterprises that utilize Virtual Desktop Infrastructures (VDI) or similar virtualized computing environments, this challenge is further exacerbated by the inability of traditional usage management tools to support usage in virtualized environments.

### SUMMARY

In accordance with the teachings of the present disclosure, the disadvantages and problems associated with entitling digital assets have been substantially reduced or eliminated.

In accordance with embodiments of the present disclosure, an information handling system for managing the entitlement of digital assets may include a storage medium and a processor. The processor may be configured to receive digital asset usage information regarding usage of a digital asset within an enterprise. The processor may also be configured to receive entitlement information regarding existing entitlements for usage of the digital asset within the enterprise. The processor may further configured to receive available entitlement information regarding entitlements other than the existing entitlements that may be acquired for usage of the digital asset within the enterprise. The processor may additionally be configured to determine based on a comparison of the digital asset usage information to the available entitlement information, whether acquisition of entitlements other than the existing entitlements is more cost efficient.

In accordance with these and other embodiments of the present disclosure, a computer-implemented method for managing the entitlement of digital assets may include receiving digital asset usage information regarding usage of a digital asset within an enterprise. The method may also include receiving entitlement information regarding existing entitlements for usage of the digital asset within the enterprise. The method may further include receiving available entitlement information regarding entitlements other than the existing entitlements that may be acquired for usage of the digital asset within the enterprise. The method may additionally include determining based on a comparison of the digital asset usage information to the available entitlement information, whether acquisition of entitlements other than the existing entitlements is more cost efficient.

In accordance with these and other embodiments of the present disclosure, an article of manufacture may include a computer readable medium computer-executable instructions carried on the computer readable medium. The instructions may be readable by a processor, the instructions, when read and executed, for causing the processor to: (i) receive digital asset usage information regarding usage of a digital asset within an enterprise; (ii) receive entitlement information regarding existing entitlements for usage of the digital asset within the enterprise; (iii) receive available entitlement information regarding entitlements other than the existing entitlements that may be acquired for usage of the digital asset within the enterprise; and (iv) determine based on a comparison of the digital asset usage information to the available entitlement information, whether acquisition of entitlements other than the existing entitlements is more cost efficient.

Technical advantages of the present disclosure may be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of an example digital assets entitlement system in accordance with components of the present disclosure;

FIGS. 3A-B illustrate block diagrams of an example unique system identifier that remains the same when one of its associated system component identifiers has been changed, in accordance with embodiments of the present disclosure;

FIGS. 4A-B illustrate block diagrams of an example unique system identifier that is changed when one of its associated system component identifiers has been changed, in accordance with embodiments of the present disclosure;

FIG. 5 illustrates a block diagram of an example encrypted unique system identifier generated from a set of system component identifiers, in accordance with embodiments of the present disclosure;

FIG. 6 illustrates a block diagram of an example unique system identifier decrypted from an encrypted unique system identifier, in accordance with embodiments of the present disclosure;

FIGS. 7A-B illustrate a flow chart of an example method for performance of digital asset entitlement operations, in accordance with embodiments of the present disclosure;

FIGS. 8A-D illustrate a flow chart of an example method for performance of digital assets entitlement and personalization operations, in accordance with embodiments of the present disclosure;

FIG. 9 illustrates a flow chart of an example method for performance of digital assets entitlement with respect to ad hoc digital asset acquisition, in accordance with embodiments of the present disclosure; and

FIG. 10 illustrates a flow chart of an example method for management digital assets entitlement, in accordance with embodiments of the present disclosure.

### DETAILED DESCRIPTION

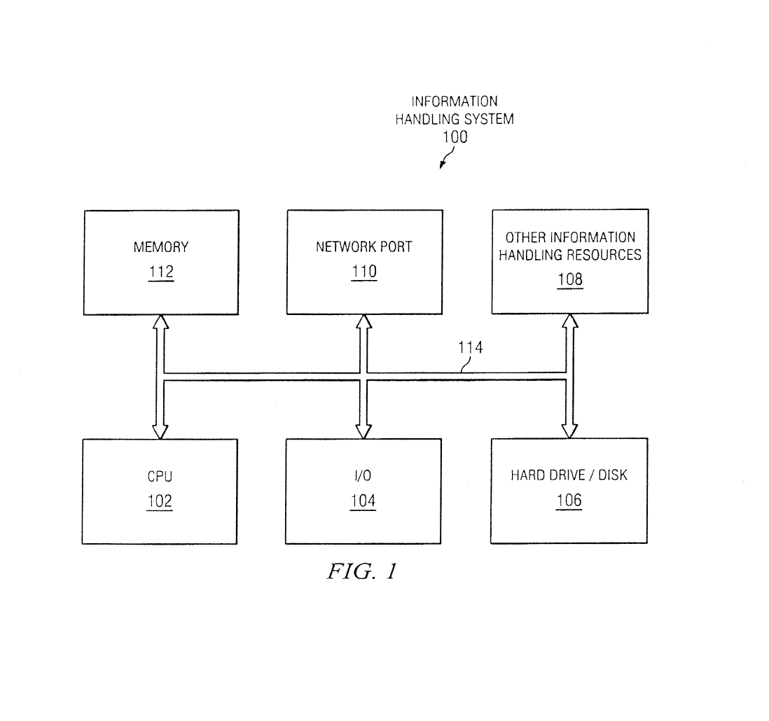

Preferred embodiments and their advantages are best understood by reference to FIGS. 1-10, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

FIG. 1 illustrates a block diagram of an example information handling system 100, in accordance with embodiments of the present disclosure. Information handling system 100 may include a processor 102, I/O devices 104, a hard drive or disk storage 106, a network port 110, a memory 112, various other information handling resources 108, all communicatively coupled to each other via one or more buses 114. In some embodiments an information handling system identification similar to that depicted in FIG. 1 may be used to implement one or more methods and/or systems disclosed herein.

A processor 102 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 102 may interpret and/or execute program instructions and/or process data stored in memory 112, hard drive 106, and/or another component of system 100.

An I/O device 104 may include any system, device, or apparatus from which processor 102 may receive input or to which processor 102 may deliver output. An I/O device may include a display, a keyboard, a mouse, other I/O devices, and/or associated controllers.

Hard drive 106 may include computer-readable media (e.g., magnetic storage media, optical storage media, opto-magnetic storage media, and/or other type of rotating storage media, flash memory, and/or other type of solid state storage media) and may be generally operable to store data and/or programs (e.g., one or more operating systems and/or one or more application programs). Although FIG. 1 depicts information handling system 100 as including one hard drive 106, information handling system 100 may include any suitable number of hard drives 106.

Network port 110 may include any suitable system, apparatus, or device operable to serve as an interface between information handling system 100 and a network. Network port 110 may enable information handling system 102 to communicate over such network using any suitable transmission protocol and/or standard, including without limitation Fibre Channel, Frame Relay, Asynchronous Transfer Mode (ATM), Internet Protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof.

Memory 112 may be communicatively coupled to processor 102 and may include any system, device, or apparatus configured to retain program instructions and/or data for a period of time (e.g., computer-readable media). Memory 112 may include random access memory (RAM), electrically erasable programmable read-only memory (EEPROM), a Personal Computer Memory Card International Association (PCMCIA) card, flash memory, magnetic storage, opto-magnetic storage, or any suitable selection and/or array of volatile or non-volatile memory that retains data after power to information handling system 100 is turned off. Although FIG. 1 depicts information handling system 100 as including one memory 112, information handling system 100 may include any suitable number of memories 112.

Other information handling resources 108 may include any component systems, devices, or apparatuses of an information handling system 100, including without limitation processors, buses, memories, I/O devices and/or interfaces, storage resources, network interfaces, motherboards, electro-mechanical devices (e.g., fans), displays, and power supplies.

The one or more buses 114 may comprise any suitable collection of systems, devices, or apparatuses configured to transfer data between various components of information handling system 100. For example, one or more buses 114 may include a serial advanced technology attachment (SATA) bus, a Peripheral Component Interconnect (PCI)/PCMCIA bus, Universal Serial Bus (USB), an SCSI bus, FireWire (IEEE 1394) bus, InfiniBand bus, any other suitable bus, or any combination of the foregoing.

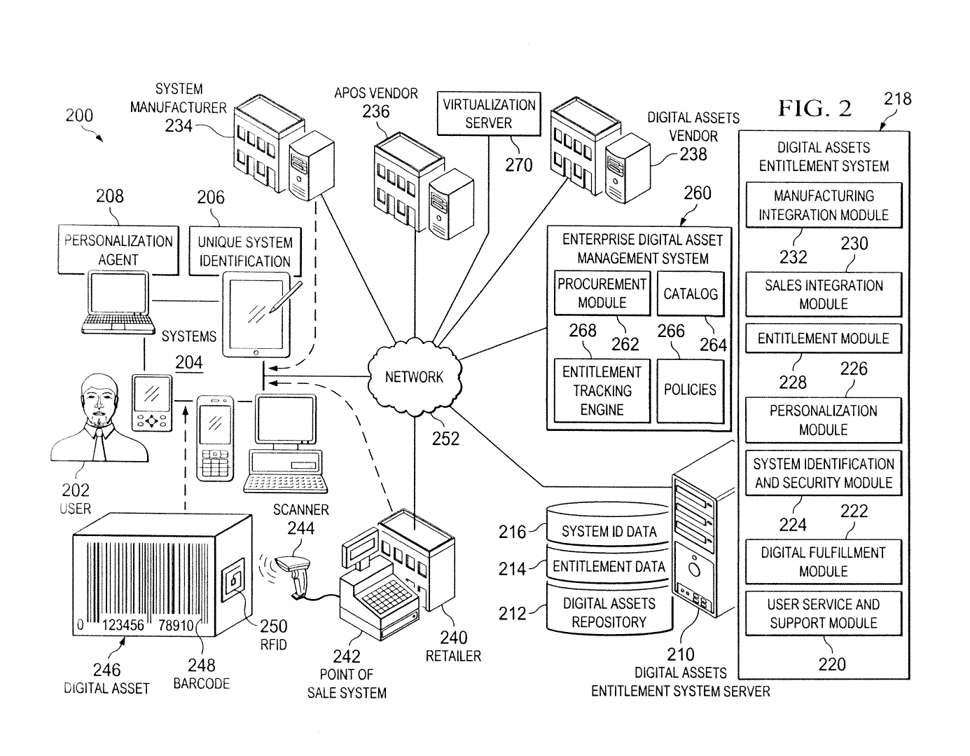

FIG. 2 illustrates a block diagram of an example digital assets entitlement system 218, in accordance with embodiments of the present disclosure. In some embodiments, digital assets entitlement system 218 may be implemented for managing the entitlement of a system 204 to process a digital asset 246. In these and other embodiments, digital assets entitlement system 218 may be implemented on one or more servers 210, which may be commercially coupled to a network 252. In various embodiments, network 252 may comprise a public network, for example the Internet, a physical private network, a virtual private network (VPN), or any combination thereof. As shown in FIG. 2, digital assets entitlement system 218 may include a user service and support module 220, a digital fulfillment module 222, and a system identification and security module 224. Digital assets entitlement system 218 may likewise comprise a personalization module 226, an entitlement module 228, a sales integration module 230, and a manufacturing integration module 232. In addition, digital assets entitlement system 218 may be configured to access a digital assets data repository 212, an entitlement data repository 214, and a system identifier (ID) data repository 216, each of which may be implemented on one or more servers 210 communicatively coupled to a network 252.

As used herein, a digital asset 246 refers to any digital asset, for example, a software application, a deliverable or performable service, music, video, software activation key, personalization instructions, files, etc. that are digitally deliverable either wholly or partially. As likewise used herein, a digital assets entitlement may refer to the association of a predetermined digital asset 246 with a target system 204. In various embodiments, an entitlement record may include the digital assets entitlement data (e.g., license information, etc.) that allows digital asset 246 to be processed by a target system 204 identified by a corresponding unique system identifier 206. In these and other embodiments, the entitlement record may be processed by entitlement module 228 and stored in entitlement data repository 214. Likewise, as used herein, a system 204 may comprise an information handling system (e.g., a personal computer, a laptop computer, a tablet computer, a PDA, a mobile telephone, or any other suitable device) operable to store a unique system ID 206, perform digital asset entitlement operations with a personalization agent, and operable to establish an online session with digital assets entitlement system 218 via network 252.

In some embodiments, digital assets entitlement and system personalization operations may be performed by a user 202, in either a physical environment or an online environment. A user 202 may comprise a system purchaser enterprise administrator, information technologist, or another suitable person. As an example, a physical environment may comprise a retailer 240 operating a physical point-of-sale (POS) system 242. As another example, an online environment may comprise a system manufacturer 234, after-point-of-sale (APOS) vendor 236, or digital assets vendor 238, that respectively accepts online orders for systems or digital assets via network 252.

If the digital assets entitlement and system personalization operations are performed in an online environment, then user 202 may decide whether to purchase a custom-configured or pre-configured system 204. If the system 204 is to be pre-configured, then it may be selected for online purchase by the user 202 and its unique identifier 206 may be determined. In some embodiments, the unique system identifier 206 may be stored in the basic input/output system (BIOS) of the pre-configured system 204. However, if the system 204 is to be custom-configured, then it may be custom-configured for online purchase by user 202. Once manufactured by system manufacturer 234, a unique system identifier may be generated as described in greater detail herein.

In various embodiments, manufacturing integration module 232 may coordinate the custom configuration of the system 204 with digital assets entitlement system 218. Likewise, system identification and security module 224 may coordinate the generation of unique system identifier 204 and its storage in the repository of system identifier data 216. User 202 may then select a digital asset 246 for online purchase, followed by selecting personalization options for the pre-configured or custom-configured system 209. In various embodiments, the personalization module 226 coordinates the selection of personalization options with digital assets entitlement system 218. As used herein, a system personalization option refers to any feature, capability, or function that may be applied to a target system 204. As an example, a personal computer desktop wallpaper or user interface options (e.g., a “classic” interface) are personalization options.

However, if the digital assets entitlement and system personalization operations are performed in a physical environment, then user 202 may select a pre-configured system 204 and physical representations of digital assets 246 to be purchased. In various embodiments, the digital asset 246 may be physically represented as images and/or text on a card or a package, yet the digital assets themselves may not be included within the card or package. User 202 may then select system personalization options for the pre-configured system 204. In various embodiments, the system personalization options may likewise be physically represented as images and/or text on a card or a package.

The digital assets product identifier (ID) may then be scanned with a scanner 244 from its corresponding physical representation, followed by scanning its corresponding digital assets activation key or other entitlement data. In various embodiments, it is not necessary to scan the digital assets activation key or other entitlement data as it is provided by digital assets entitlement system 218 during digital asset entitlement operations described in greater detail herein. Data related to the previously selected personalization options may then likewise be scanned, followed by determining unique system identifier 206 of pre-configured system 204. In various embodiments, the digital assets product ID, its associated activation key or entitlement data, the personalization option data, and the unique system identifier may be represented by a bar code 248 or other indicia on a card or physical package. In various other embodiments, the digital assets product ID, its associated activation key or entitlement data, the personalization option data, and the unique system identifier may be stored in a radio frequency identifier (RFID) 250 tag affixed to the physical representation of the digital asset. Those of skill in the art may appreciate that many such embodiments are possible and that the foregoing is not intended to limit the spirit, scope, or intent of the disclosure.

A purchase transaction for the custom-configured or pre-configured system 204 and any associated digital assets 246 and personalization options may then be completed. In various embodiments, the processing of the purchase transaction may be performed by the sales integration module 230. In these and other embodiments, the financial proceeds of the purchase transaction may be settled between multiple parties. For example, a system manufacturer 234 may receive a portion of the purchase transaction corresponding to the cost of the system 204. One or more digital assets vendors 238 may likewise receive a proportionate share of the purchase transaction corresponding to the digital asset 246 they respectively provide.

Digital asset entitlement operations, as described in greater detail herein, may then be performed by digital assets entitlement system 218 to bind the digital assets 246, the personalization options, and their respective digital assets entitlement data to unique system identifier 206 of target system 204. The resulting bound data, including data associated with the digital assets (e.g., installation files, etc.) may then be stored in the repository of entitlement data 214 and purchased system 204 may then be delivered to user 202 or another person designated by user 202. In various embodiments, entitlement module 228 may generate, and then process, the digital assets entitlement data and user service and support module 220 may coordinate the delivery of system 204 to user 202 or another person designated by user 202.

Standard operating system (OS) out-of-the-box-experience (OOBE) or hypervisor boot operations may be performed on the system 204, followed by loading a personalization agent 208. In various embodiments, the personalization agent 208 has a unique identifier that may be associated with one or more unique system component identifiers. In some embodiments, the unique identifier of the personalization agent may be uniquely associated with the current unique system identifier 206 associated with the system 204. In other embodiments, a portion of the personalization agent 208 may be delivered to the system 204 in an encrypted form and may then be decrypted prior to being loaded on the system 204. In these embodiments, the primary system identifier (e.g., service tag number, serial number, etc.), may be used as a decryption key to decrypt the personalization agent 208.

In these and other embodiments, secondary system identifiers may be stored on system 204 (e.g., in the BIOS, in flash memory, on a hard disk, etc.) as well as in digital assets entitlement system 218. In these and other embodiments, digital assets entitlement system 218 may use the secondary system identifiers to encrypt a portion of personalization agent 208 before it is downloaded to system 204. Once downloaded, the unencrypted portion of personalization agent 208 may use the secondary system identifiers stored on system 204 to decrypt the encrypted portion of personalization agent 208. In some embodiments, the secondary system identifiers may likewise be encrypted and may first be decrypted before they are used to decrypt the encrypted portion of personalization agent 208. In other embodiments, the secondary system identifiers may be stored in a Trusted Platform Module (TPM). Skilled practitioners of the art may appreciate that many such embodiments are possible and the foregoing is not intended to limit the spirit, scope, or intent of the disclosure.

Personalization agent 208 may query target system 204 for its unique system identifier 206. In various embodiments, unique system identifier 206 associated with system 204 may be stored in the target system's BIOS, flash memory, a hard disk, and/or other memory device.

Personalization agent 208 may then automatically establish a communication session with digital assets entitlement system 218 and use unique system identifier 206 to authenticate system 204. Unique system identifier 206 may then be used by the personalization agent 208 to determine entitled digital assets and personalization options corresponding to the unique system identifier 206.

Once determined, the corresponding personalization options and digital assets 246, along with their associated digital assets entitlement data, may be respectively downloaded to target system 204 from the repository of digital assets 212 and the repository of entitlement data 214. In some embodiments, the personalization options and digital assets 246, along with their associated digital assets entitlement data 214, may be downloaded from a single server 210 on network 252. In other embodiments, the personalization options and digital assets 246 may be downloaded from one or more servers 210 on network 252. In yet other embodiments, the personalization options, digital assets 246, and associated digital assets entitlement data 214 may be respectively downloaded from a plurality of servers 210 on network 252. As an example, a first digital asset 246 may be provided by system manufacturer 234 and a second digital asset 246 may be provided by a digital assets vendor 238. Likewise, a plurality of digital assets 246 may be provided by a corresponding plurality of digital assets vendors 238. Skilled practitioners of the art may appreciate that many such embodiments and examples are possible and the foregoing is not intended to limit the spirit, scope, or intent of the disclosure.

In various embodiments, digital assets entitlement system 218 may manage the respective location of the personalization options, digital assets 246, and associated digital assets entitlement data 214 to initiate its provision. Once downloaded, personalization agent 208 may use digital assets entitlement data 214 to install digital assets 246 and personalization options on system 204. Thereafter, user 202 or another person may decide to perform an APOS purchase of digital asset 246. As used herein, an APOS purchase of digital assets may refer to any purchase of digital asset 246 made after the initial online or physical purchase of system 204. In various embodiments, the APOS purchase of a digital asset 246 may be performed in a physical, online, or enterprise point-of-sale environment. If the APOS purchase is performed in an online environment, for example from APOS vendor 236, then user 202 or another person may select a digital asset 246 for online purchase. Personalization agent 208 may then determine unique system identifier 206 of system 204. An APOS purchase transaction may then be performed for purchase of the selected digital asset 246. However, if the APOS purchase is performed in a physical environment, then the user 202 or another person may select a physical representation of a digital asset 246 to be purchased. The digital assets product ID may then be scanned from its corresponding physical representation, followed by scanning its corresponding digital assets activation key or other entitlement data.

Digital asset entitlement operations, as described in greater detail herein, may then be performed by digital assets entitlement system 218 to bind digital assets 246 and their respective digital assets entitlement data 214 associated with the APOS purchase to unique system identifier 206 of target system 204. The resulting bound data, including data associated with the digital assets (e.g., installation files, etc.) may then be stored, as described in greater detail herein, in digital assets entitlement system 218. Personalization agent 208, as likewise described in greater detail herein, then automatically establishes a communicative session with digital assets entitlement system 218, and may download the purchased digital assets 246 and their associated digital assets entitlement data 214. Once downloaded, personalization agent 208 may then use the associated digital assets entitlement data 214 to install the downloaded digital asset 246 on system 204.

In various embodiments, an enterprise digital asset management system 260 may manage and track usage and entitlements of digital assets for a plurality of systems 204 associated with an enterprise. In some embodiments, enterprise digital asset management system 260 may communicate and coordinate with digital assets entitlement system 218 to perform digital asset entitlement operations, as described in greater detail herein. For example, enterprise digital asset management system 260 may maintain policies 266. Policies 266 may be configured by an administrator of an enterprise and may comprise a database, list, map, table, or other data structure setting forth one or more digital assets and, for each digital asset, the systems 204 and/or users authorized to use such digital asset. Based on such policies 266, enterprise digital asset management system 260 may communicate with digital assets entitlement system 218 regarding the systems 204 authorized to use various digital assets, and digital assets entitlement system 218 may perform digital assets entitlement operations based on such entitlement management data 266.

As shown in FIG. 2, enterprise digital asset management system 260 may also comprise a procurement module 262. Procurement module 262 may be configured to interface with individual systems 204, to allow users of systems 204 to submit requests for entitlements for digital assets for their individual systems 204, and further be configured to interface with digital assets entitlement system 218 to perform digital asset entitlement operations. For example, procurement module 262 may present to a user at a system 204 a list of available digital assets set forth in catalog 264. Catalog 264 may include a list, table, map, database, or other data structure setting forth various digital assets that may be available for users of system 204 to request to have entitled for their various systems 204. In some embodiments, a user selection of a digital asset for entitlement may be received by the procurement module 262 for approval (e.g., approval by an administrator). In these and other embodiments, policies 266 may be analyzed by the procurement module to determine if usage of the digital asset by the user or system is consistent with the policies 266, and if so, the request may be automatically approved. Once approved, an order for the digital asset may be made if needed, and the digital assets entitlement system 218 may perform digital asset entitlement operations to entitle the digital asset for use in accordance with the user request, as described in this disclosure.

Entitlement tracking engine 268 of enterprise digital asset management system 260 may track the usage of various digital assets used in an enterprise, including digital assets used by systems 204 and virtualization server 270. To facilitate such tracking, information regarding entitlements and execution of digital assets within the enterprise may be communicated to entitlement tracking engine 268 from digital assets entitlement system 218, individual systems 204, and/or virtualization server 270. For example, entitlement data 214 associated with the enterprise may be received by entitlement tracking engine 268 from digital assets entitlement system 218. As another example, each time a digital asset is used at a system 204, the occurrence of such usage may be communicated to entitlement tracking engine 268. As a further example, each time a digital asset is utilized by virtualization server 270, the occurrence of such usage may be communicated to entitlement tracking engine 268. As used herein “usage” may broadly refer to any usage associated with a digital asset, including installation or execution of the digital asset.

Based on such received information, entitlement tracking engine 268 may compare usage information with entitlement information to determine if usage is consistent with the entitlements. If usage is not consistent with the entitlements, entitlement tracking engine 268 may initiate the acquisition of the appropriate entitlement or entitlements, and digital entitlement operations may be performed as described in this disclosure. Alternatively, in some cases, if usage is significantly less than the available entitlements for a particular asset, entitlement tracking engine 268 may initiate the termination of the appropriate entitlement or entitlements.

In addition, entitlement tracking engine 268 may also be configured to analyze the received information for each digital asset and compare it to the terms of available entitlements (e.g., available software license terms) for the digital asset in order to determine whether it may be economically more efficient to acquire different entitlements for the digital asset. For example, analysis may indicate that usage of a digital asset may be such that the enterprise is eligible for a different type of entitlement for the digital asset that may be more cost-efficient than the present entitlement (e.g., usage has increased to where a high-volume license is available). As another example, analysis may indicate that usage of a digital asset may be such that it may be more cost-efficient to downgrade a license (e.g., the enterprise has an enterprise-wide license, but the digital asset is used so sparingly that an entitlement allowing for usage of a small number of copies of the digital asset is more economical). As a further example, available entitlements may change (e.g., a software publisher may provide new or alternative licensing terms), and analysis of usage with such new entitlement terms may be made to determine whether it is beneficial to change an entitlement for a particular digital asset.

As mentioned above, an enterprise may employ a virtualized computing environment. In a virtualized computing environment, a system 204 may be virtualized, in that one or more of the user interface components (e.g., the “desktop”) of the system may be stored at a physical information handling system (e.g., virtualization server 270) remote from the system 204, rather than stored locally on the system 204. Accordingly, when a virtualized system 204 is used, some or all of the programs, applications, processes, and/or data used are kept on virtualization server 270 and executed centrally from virtualization server 270.

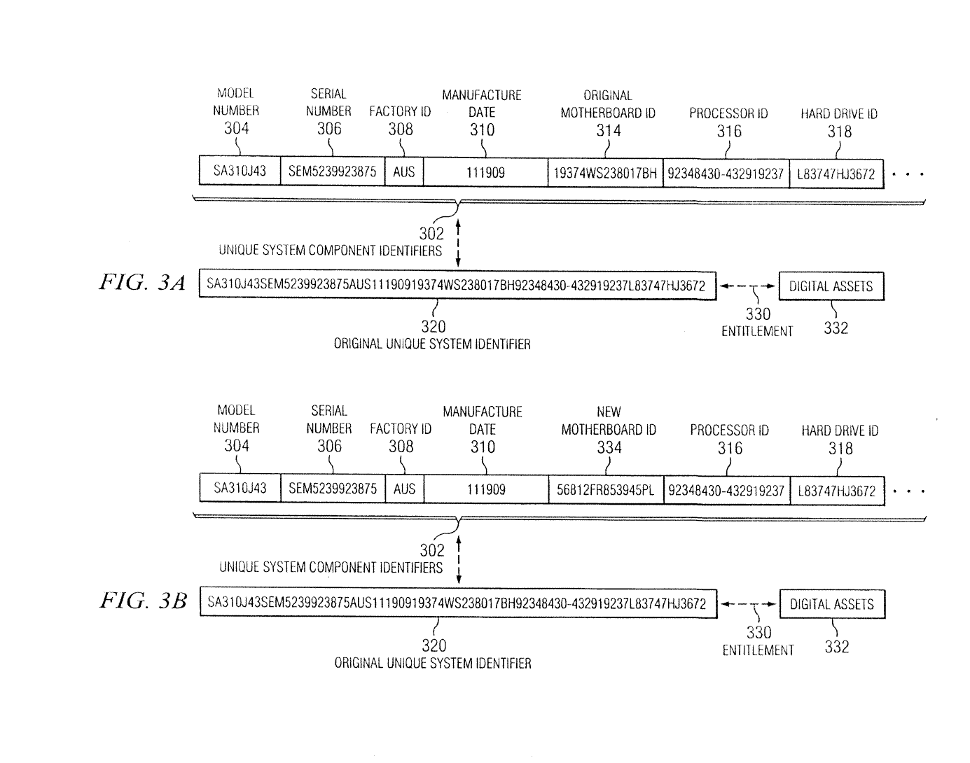

FIGS. 3A-B illustrate a block diagram of an example unique system identifier 320 that remains the same when one of its associated system component identifiers has been changed; in accordance with embodiments of the present disclosure. As shown in FIG. 3A, an original unique system identifier 320 may be generated from a plurality of unique system component identifiers 302, which correspond to a plurality of system components included in a target system 204. As likewise shown in FIG. 3A, unique system component identifiers 302 may comprise a Model Number 304 ‘SA310J43’, a Serial Number 306, sometimes referred to as a service tag number or a primary system identifier, ‘SEM5239923875’, a Factory ID 308 ‘AUS’, and a Manufacture Date 310 ‘111909’. Unique system component identifiers 302 may likewise comprise an Original Motherboard ID 314 ‘19374WS238017BH’, a Processor ID 316 ‘92348430-432919237’, a Hard Drive ID 318 ‘L83747HJ3672’, etc.

As described in greater detail herein, once generated, original unique system identifier 320 may be associated, such as, for example, through a binding operation, with predetermined digital assets 332 to generate a digital assets entitlement 330. As likewise described in greater detail herein, digital assets entitlement 330 entitle a target system 204, which may be associated with the original unique system identifier 320, to process the digital assets 332. However, it is not uncommon for system components to be replaced due to failure, erratic performance, becoming outmoded, or for other reasons. It will be appreciated that the entitlement 330 between original unique system identifier 320 and digital assets 332 may be compromised as a result of such a replacement. For example, as illustrated in FIG. 3B, the Original Motherboard ID 314 ‘19374WS238017BH’ may be replaced with a New Motherboard ID 334 ‘56812FR853945PL’. However, in such case the original unique system identifier 320 may remain unchanged.

In various embodiments, extract, transform, and load (ETL) and other database operations may be performed to manage the integrity of the relationship between original unique system identifier 320 and the plurality of unique system component identifiers 302. As an example, Original Motherboard ID 314 ‘19374WS238017BH’ may remain as a subset of original unique system identifier 320, even though it may have been deactivated or invalidated as a unique system component identifier 302. However, in these and other embodiments, relational database operations known to those of skill in the art may be applied to maintain the relationship between original unique system identifier 320, New Original Motherboard ID 334 ‘56812FR853945PL’, and unchanged unique system component identifiers 302. Accordingly, the integrity of entitlement 330 between original unique system identifier 320 and digital assets 332 may be perpetuated. It may be appreciated by skilled practitioners of the art that many such embodiments are possible and the foregoing is not intended to limit the spirit, scope, or intent of the disclosure.

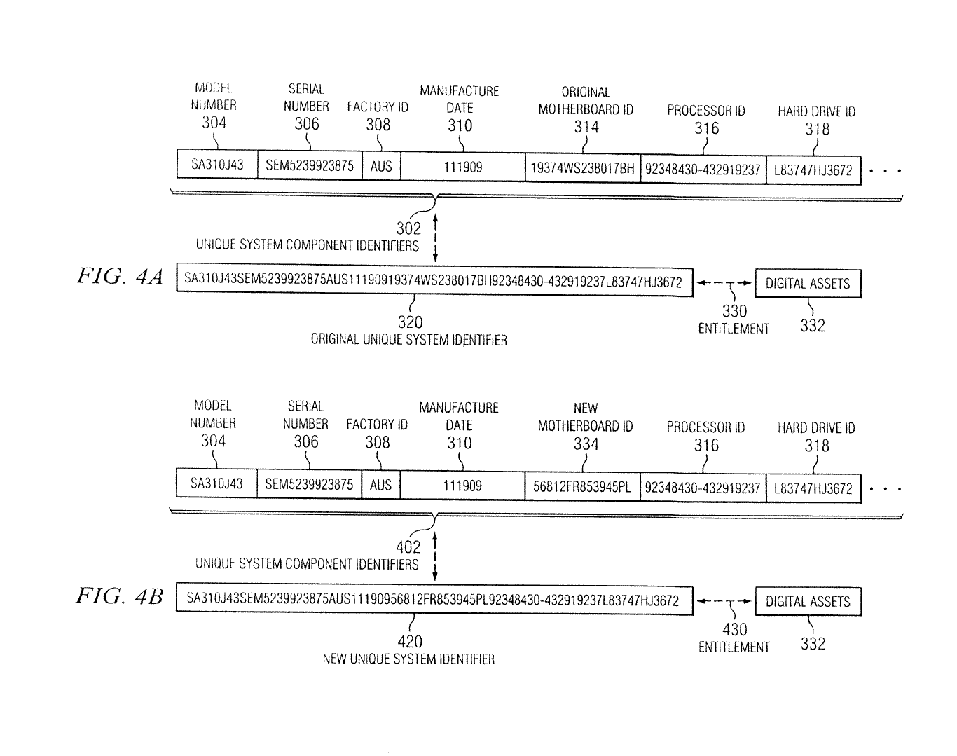

FIGS. 4A-B illustrate a block diagram of an example unique system identifier 320 that is changed when one of its associated system component identifiers has been changed, in accordance with embodiments of the present disclosure. As shown in FIG. 4A, an original unique system identifier 320 may be generated from a plurality of unique system component identifiers 302, which correspond to a plurality of system components included in a target system 204. As likewise shown in FIG. 3A, unique system component identifiers 302 may comprise Model Number 304 ‘SA310J43’, Serial Number 306, sometimes referred to as a service tag number or a primary system identifier, ‘SEM5239923875’, Factory ID 308 ‘AUS’, and Manufacture Date 310 ‘111909’. Unique system component identifiers 302 may likewise comprise Original Motherboard ID 314 ‘19374WS238017BH’, Processor ID 316 ‘92348430-432919237’, Hard Drive ID 318 183747HJ3672′, etc.

As described in greater detail herein, once generated, original unique system identifier 320 may be associated, such as, for example, through a binding operation, with predetermined digital assets 332 to generate a digital assets entitlement 330. As likewise described in greater detail herein, digital assets entitlement 330 entitles a target system 204, which may be associated with original unique system identifier 320, to process digital assets 332. However, it is not uncommon for system components to be replaced due to failure, erratic performance, becoming outmoded, or for other reasons. It will be appreciated that entitlement 330 between the original unique system identifier 320 and digital assets 332 may be compromised as a result of such a replacement. For example, as illustrated in FIG. 4B, Original Motherboard ID 314 ‘19374WS238017BH’ may be replaced with New Motherboard ID 334 ‘56812FR853945PL’. As result, a new unique system identifier 420 may be generated, which may be a concatenation of the plurality of unique system component identifiers 402, including New Original Motherboard ID 334 ‘56812FR853945PL’ as a subset.

In various embodiments, a first set of operations may be performed to remove entitlement 330 between original unique system identifier 320 and digital assets 332. A second set of operations may then be performed to associate new unique system identifier 420 with digital assets 332 to generate a new entitlement 430. In these and other embodiments, original unique system identifier 320 may then be invalidated. Accordingly, the integrity of original entitlement 330 between original unique system identifier 320 and digital assets 332 may be perpetuated by new entitlement 430 between new unique system identifier 420 and digital assets 332. Skilled practitioners of the art may appreciate that many such embodiments are possible and the foregoing is not intended to limit the spirit, scope, or intent of the disclosure.

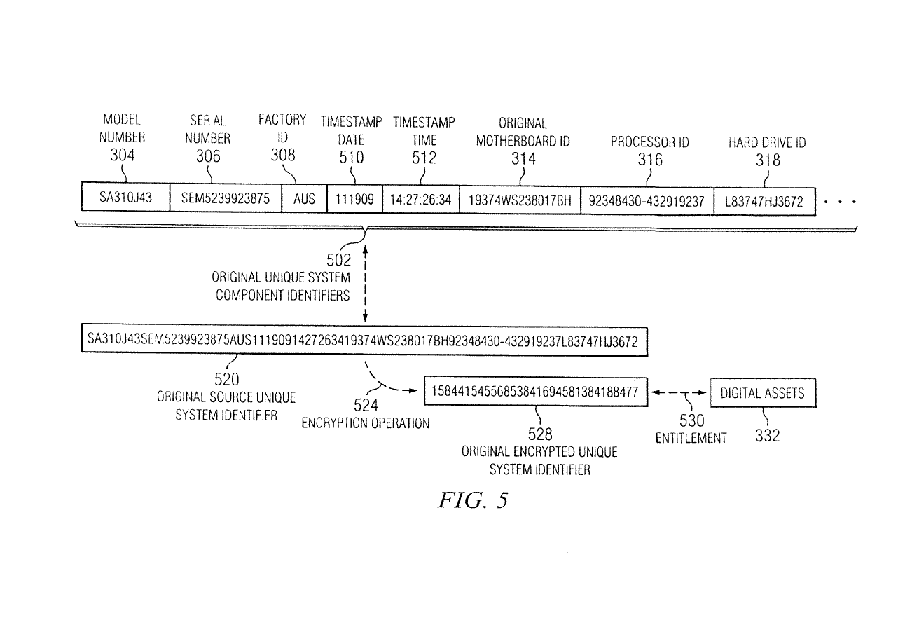

FIG. 5 illustrates a block diagram of an example encrypted unique system identifier 528 generated from a set of system component identifiers, in accordance with embodiments of the present disclosure. In these embodiments, a source unique system identifier 520 may be generated from a plurality of original unique system component identifiers 502, which may correspond to a plurality of system components included in a target system 204. As shown in FIG. 5, original unique system component identifiers 502 may comprise Model Number 304 ‘SA310J43’, Serial Number 306, sometimes referred to as a service tag number or a primary system identifier, ‘SEM5239923875’, Factory ID 308 ‘AUS’, Timestamp Date 510 ‘111909’, and Timestamp Time 512 ‘14:27:26:34’. Original unique system component identifiers 502 may likewise comprise Original Motherboard ID 314 ‘19374WS238017BH’, Processor ID 316 ‘92348430-432919237, Hard Drive ID 318 183747HJ3672’, etc.

An encryption operation 524 may then be performed on source unique system identifier 520 to generate original encrypted unique system identifier 528. In various embodiments, the encryption operation may comprise the use of a private key, a public key, key pairs, or any combination of keys and cryptographic operations such as implemented in a public key infrastructure (PKI), for example. As an example, the original encrypted unique system identifier 528 may be generated using a private key associated with the manufacturer of the system and a public key associated with the system itself. In some embodiments, the Timestamp Date 510 ‘111909’ and the Timestamp Time 512 ‘14:27:26:34’ may likewise be used to generate the encrypted unique system identifier 528. Skilled practitioners of the art may be familiar with such cryptographic operations and may appreciate that many such embodiments are possible and that the foregoing is not intended to limit the spirit, scope, or intent of the disclosure.

As described in greater detail herein, once generated, original encrypted unique system identifier 528 may be associated, such as, for example, through a binding operation, with predetermined digital assets 332 to generate a digital assets entitlement 530. As likewise described in greater detail herein, digital assets entitlement 530 may entitle a target system 204, which may be associated with original encrypted unique system identifier 528, to process digital assets 332.

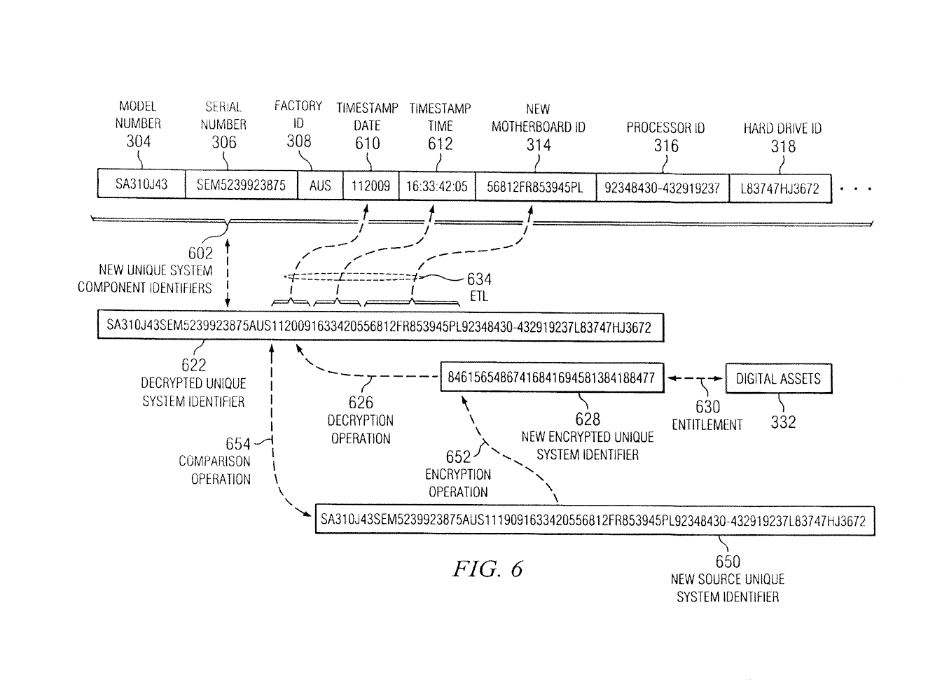

FIG. 6 illustrates a block diagram of an example unique system identifier decrypted from an encrypted unique system identifier 622, in accordance with embodiments of the present disclosure. It is not uncommon for system components to be replaced due to failure, erratic performance, becoming outmoded, or for other reasons. However, the replaced system component will typically have a different unique system component identifier. As a result, the entitlement association between a unique system identifier and predetermined digital assets may be compromised as a result of such a replacement, which in turn may prevent target system 204 from processing the digital assets 246.

In various embodiments, the unique system component identifier of the replacement system component may be unknown until it is replaced in the target system 204. In these and other embodiments, the system component may be replaced in the target system 204, the target system may then be initiated (e.g., booted), and an inventory of unique system component identifiers may be performed. In some embodiments, one or more unique system component identifiers, for example a serial number or service tag, may be visible and may be visually inventoried. In other embodiments, one or more unique system component identifiers, for example a motherboard, processor, or hard drive serial number, may not be visible and may be automatically inventoried.

As shown in FIG. 6, a new source unique system identifier 650 may be generated from the inventoried unique system component identifiers. In some embodiments, a time stamp date and a time stamp time may be components of new source unique system identifier 650. In these embodiments, the time stamp date and a time stamp time may be used to validate the authenticity of new source unique system identifier 650. As an example, the provider of the replacement part may have stipulated that the replacement part be replaced on Nov. 12, 2009, between 8:00 AM and 6:00 PM. Accordingly, a time stamp date of Nov. 12, 2009 and a time stamp time of 16:33:42:05 may provide validation that the replacement part was replaced within the specified date and time interval.

An encryption operation 652 may then be performed on new source unique system identifier 650 to generate a new encrypted unique system identifier 628. As an example, the encryption operation may be performed using a private key associated with the target system and a public key associated with the provider of the replacement system component. The new encrypted unique system identifier 628 may then be communicated to digital assets entitlement system 218, which may in turn perform a decryption operation 626 to generate a decrypted unique system identifier 622.

As likewise shown in FIG. 6, ETL and other database operations 634 may be performed on the decrypted unique system identifier 622 to generate new unique system component identifiers 602. As shown in FIG. 6, the new unique system component identifiers may now comprise Model Number 304 ‘SA310J43, Serial Number 306, ‘SEM5239923875’, Factory ID 308 ‘AUS’, Timestamp Date 610 ‘112009’, and Timestamp Time 612 ‘16:33:42:05’. New unique system component identifiers 602 may likewise comprise New Motherboard ID 314 ‘56812FR853945PL’, Processor ID 316 92348430-432919237, Hard Drive ID 318 ‘L83747HJ3672’, etc. In some embodiments, Timestamp Date 610 and Timestamp Time 612 may be compared to previously authorized timestamp date and timestamp times to validate the authenticity of new unique system component identifiers 602 and their corresponding decrypted unique system identifier 622. In these and other embodiments, if the decrypted unique system identifier 622 is validated, then a first set of operations may be performed to remove entitlement 330 between the original encrypted unique system identifier and digital assets 332. A second set of operations may then be performed to associate new encrypted unique system identifier 628 with digital assets 332 to generate new entitlement 630. Accordingly, the integrity of the original entitlement between the original encrypted unique system identifier and digital assets 332 may be perpetuated by new entitlement 630 between new encrypted unique system identifier 628 and digital assets 332.

In various other embodiments, the provider of the replacement system component may be able to determine its associated unique system component identifier. In some embodiments, the unique system component identifier may be known in advance. In other embodiments, the unique system component identifier may be one of a pool of, or a range of, possible unique system component identifiers set aside for replacement purposes. As described in greater detail herein, a new source unique identifier may be generated, using the unique system component identifier of the component to be replaced. Once the new source unique identifier is generated, the unique system component identifier of the replaced system component may be invalidated. In these and other embodiments, the system component may be replaced in the target system, the target system may then be initiated (e.g., booted), and an inventory of unique system component identifiers may be performed. In some embodiments, one or more unique system component identifiers, for example a serial number or service tag, may be visible and may be visually inventoried. In other embodiments, one or more unique system component identifiers, for example a motherboard, processor, or hard drive serial number, may not be visible and may be automatically inventoried.

As shown in FIG. 6, a new source unique system identifier 650 may be generated from the inventoried unique system component identifiers. In some embodiments, a time stamp date and a time stamp time may be components of new source unique system identifier 650. In these embodiments, the time stamp date and a time stamp time may be used to validate the authenticity of new source unique system identifier 650. An encryption operation 652 may then be performed on new source unique system identifier 650 to generate new encrypted unique system identifier 628. As an example, the encryption operation may be performed using a private key associated with the target system and a public key associated with the provider of the replacement system component. The new encrypted unique system identifier 628 may then be communicated to a digital assets entitlement system, which in turn may perform a decryption operation 626 to generate a decrypted unique system identifier 622.

Comparison operations 654 may then be performed between the new source unique system identifier and decrypted unique system identifier 622. If comparison operations 654 are successful, then a first set of operations may be performed to remove the entitlement 330 between the original encrypted unique system identifier and digital assets 332. A second set of operations may then be performed to associate new encrypted unique system identifier 628 with digital assets 332 to generate a new entitlement 630. Accordingly, the integrity of the original entitlement between the original encrypted unique system identifier and digital assets 332 may be perpetuated by the new entitlement 630 between the new encrypted unique system identifier 628 and the digital assets 332. Skilled practitioners of the art may appreciate that many such embodiments are possible and the foregoing is not intended to limit the spirit, scope, or intent of the disclosure.

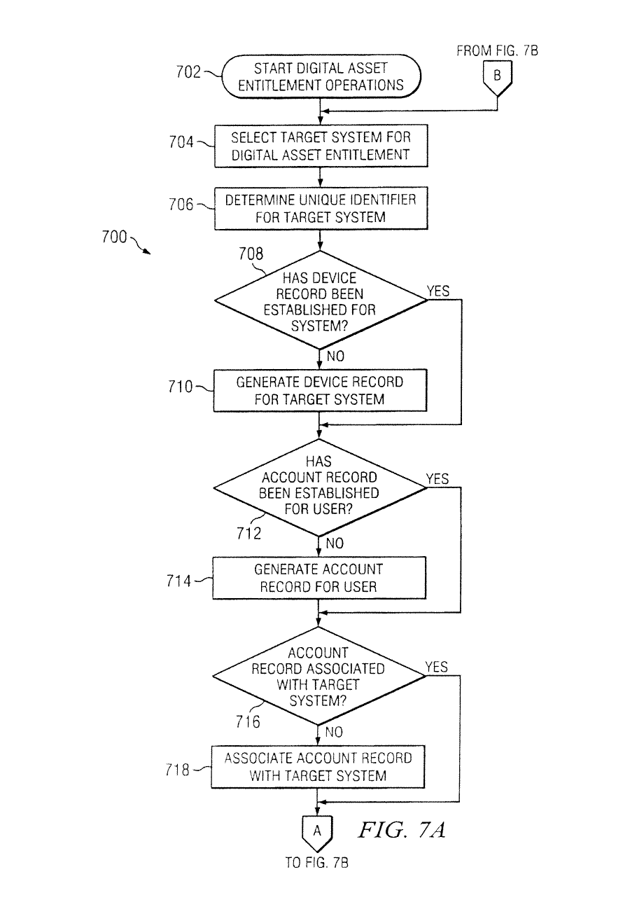

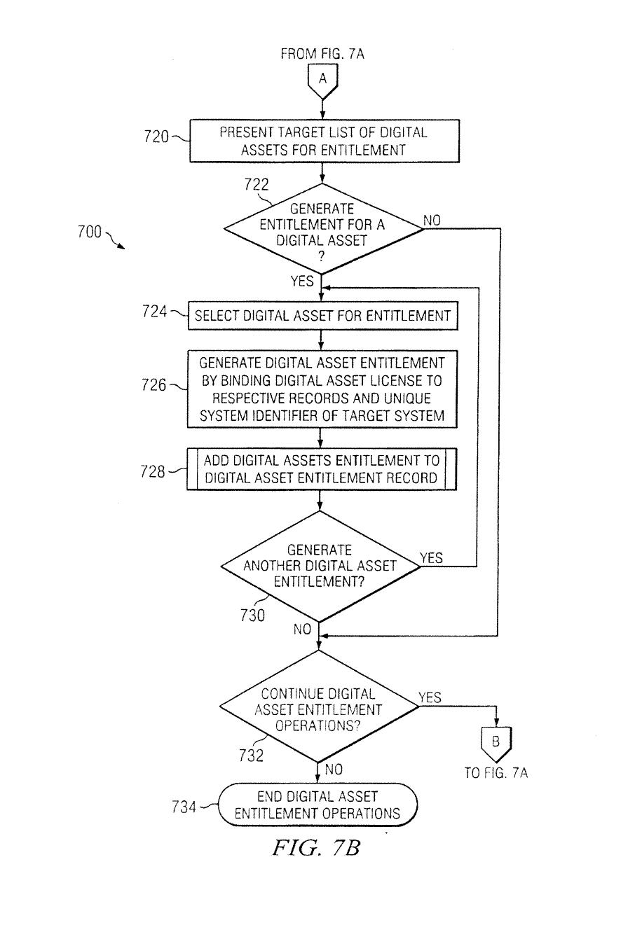

FIGS. 7A-B illustrate a flow chart of an example method 700 for performance of digital asset entitlement operations, in accordance with embodiments of the present disclosure. According to certain embodiments, method 700 may begin at step 702. As noted above, teachings of the present disclosure may be implemented in a variety of configurations of system 200. As such, the preferred initialization point for method 700 and the order of the steps 702-734 comprising method 700 may depend on the implementation chosen.

In method 700, digital asset entitlement operations may be started in step 702, followed by the selection of a target system in step 704 for digital assets entitlement. The unique system identifier of the target system, as described in greater detail herein, may be determined in step 706, followed by a determination being made in step 708 whether a device record has been established for the target system. If not, then the device record may be generated in step 710. As used herein, a device record may refer to a data record comprising data related to a system which will receive an entitlement to process associated digital assets. In various embodiments, the unique system identifier of the target system may be stored in the device record. In various embodiments, other records may be associated with the device record to further describe the system, such as, for example, its model, type, make, internal identifiers, etc.

Once the device record has been generated, or if it is determined in step 708 that it has already been established, then a determination may be made in step 712 whether an account record has been established for a user. If not, then the account record may be generated for the user in step 714. As used herein, an account record may refer to a data record comprising data related to the association of multiple devices or systems to one or more entities. In various embodiments, the entity may be a single individual or a group of individuals. As an example, the entity may be a household with multiple PCs, a small business with several employees, a large corporation with many employees, etc. Other records may be attached to the account to further describe the account holder, payment information related to the account, etc. Accounts may further be broken down or organized into sub-accounts as needed (e.g., to describe departments within an enterprise). In various embodiments, a user may be associated with a single device or system or multiple devices or systems in the account record. Conversely, a group of users may be associated with a single device or system or multiple devices in the account record. Further, more groups of individual users may likewise be associated with groups of individual devices or systems. Those of skill in the art may appreciate that many such associations are possible and the foregoing is not intended to limit the spirit, scope, or intent of the disclosure. Once the account record has been generated, or if it is determined in step 712 that it has already been established, then a determination may be made in step 716 whether the account record may be associated with the target system. If not, then the account record may be associated with the target system in step 718.

Once the account record has been associated with the target system, or if it is determined in step 716 that it has already been associated, then a target list of digital assets may be presented in step 720 for entitlement. A determination may then be made in step 722 whether to generate an entitlement for a digital asset. If not, then a determination may be made in step 732 whether to continue digital asset entitlement operations. If so, then the process may be continued, proceeding with step 704. Otherwise digital asset entitlement operations may be ended in step 734. However, if it is determined in step 722 to generate an entitlement for a digital asset, then a target digital asset may be selected in step 724. A digital assets entitlement may then be generated in step 726 by performing operations to associate the selected digital asset's corresponding license record with the aforementioned device record, account record, and/or other predetermined records. The resulting digital assets entitlement association may then be added to the entitlement record in step 728. A determination may then be made in step 730 whether to generate another digital assets entitlement. If so, the process may be continued, proceeding with step 724. Otherwise, a determination may be made in step 732 whether to continue digital asset entitlement operations. If so, then the process may be continued, proceeding with step 704. Otherwise digital asset entitlement operations may be ended in step 734.

Although FIGS. 7A and 7B disclose a particular number of steps to be taken with respect to method 700, method 700 may be executed with greater or lesser steps than those depicted in FIGS. 7A and 7B. In addition, although FIGS. 7A and 7B disclose a certain order of steps to be taken with respect to method 700, the steps comprising method 700 may be completed in any suitable order.

Method 700 may be implemented using information handling system 100, system 200, components thereof, and/or any other system operable to implement method 700. In certain embodiments, method 700 may be implemented partially or fully in software and/or firmware embodied in computer-readable media.

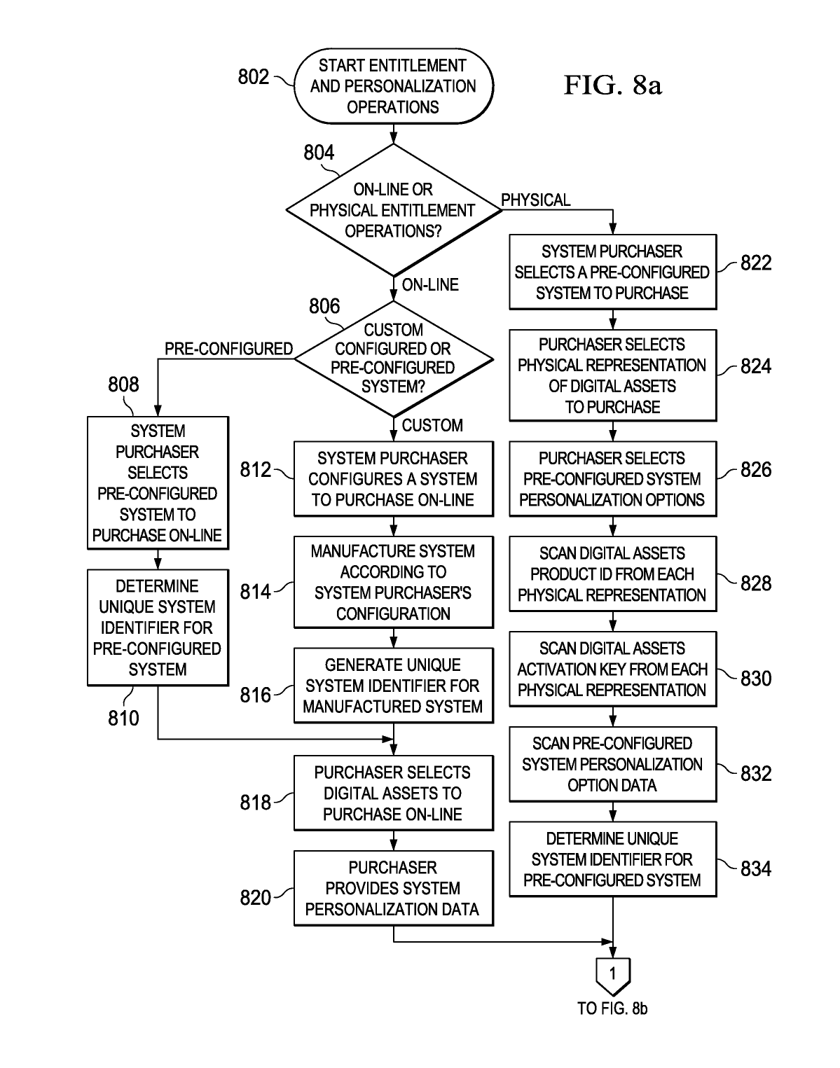

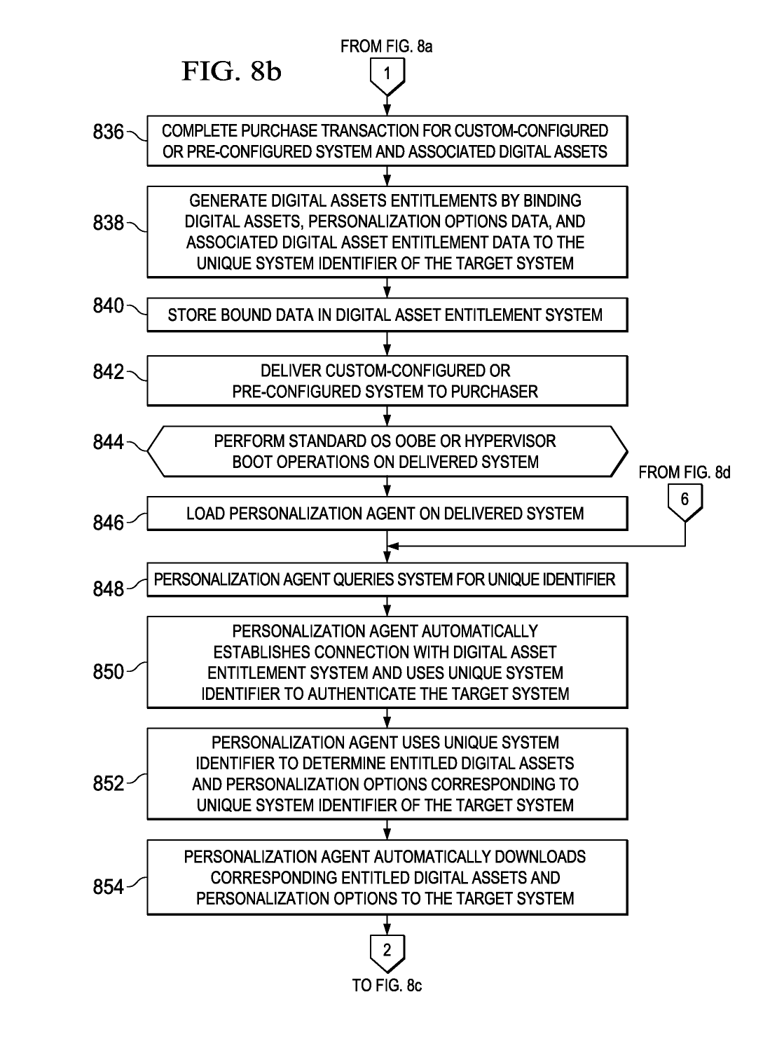

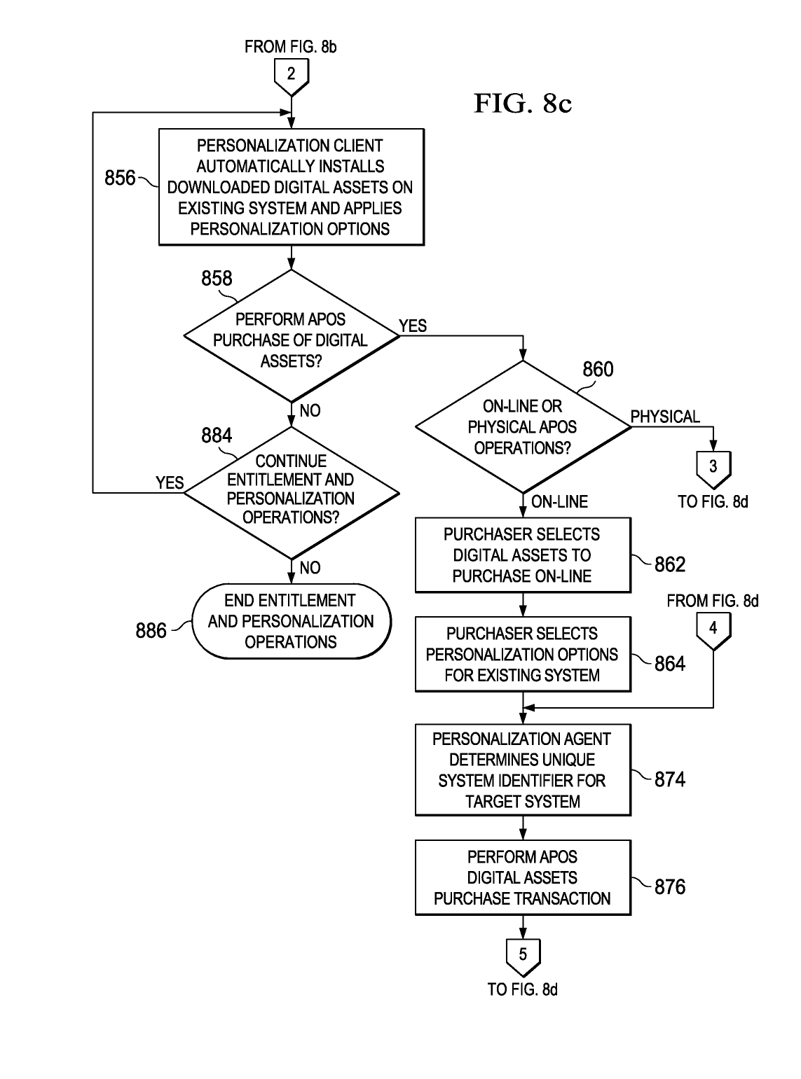

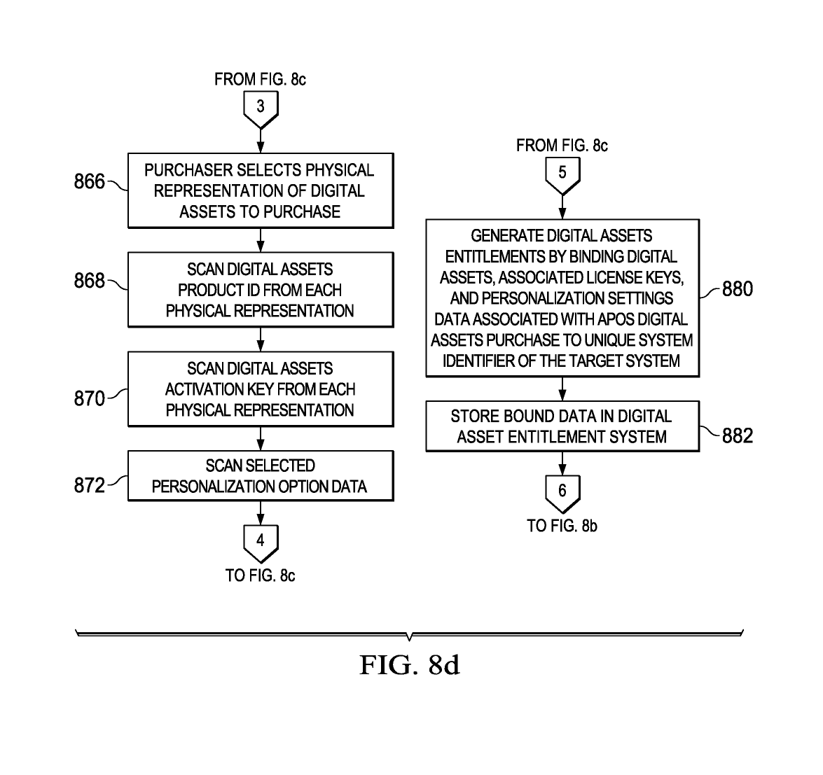

FIGS. 8A-D illustrate a flow chart of an example method 800 for performance of digital assets entitlement and personalization operations, in accordance with embodiments of the present disclosure. According to certain embodiments, method 800 may begin at step 802. As noted above, teachings of the present disclosure may be implemented in a variety of configurations of system 200. As such, the preferred initialization point for method 800 and the order of the steps 802-886 comprising method 800 may depend on the implementation chosen.

As shown in FIG. 8, digital assets entitlement and system personalization operations may be begun by a user in step 802, followed by a determination being made in step 804 whether the entitlement and system personalization operations are performed in a physical environment or an online environment. If it is determined in step 804 that the digital assets entitlement and system personalization operations are performed in an online environment, then a determination may be made in step 806 whether the target system is to be custom-configured or pre-configured. If it is determined in step 806 that the target system is to be a pre-configured system, then the user may select the target system for online purchase in step 808. The unique identifier for the selected pre-configured system may then be determined in step 810. In some embodiments, the unique system identifier may be stored in the BIOS of the pre-configured target system.

However, if it is determined in step 806 that the target system is to be a custom-configured system, then the user may configure the target system for online purchase in step 812. The target system may then be manufactured in step 814 according to the custom configuration selections made by the user in step 812. Once manufactured, a unique system identifier may be generated in step 816, as described in greater detail herein. Then, or after the unique system identifier is determined for the pre-configured system in step 810, the user may select digital assets for online purchase in step 818, followed by selecting personalization options for the custom-configured system in step 820.

However, if it is determined in step 804 that the entitlement and system personalization operations are to be performed in a physical environment, then the user may select a pre-configured system in step 822 to purchase. The user may then select a physical representation of digital assets to be purchased in step 824. In various embodiments, the digital assets are physically represented as images and text on a card or a package, yet the digital assets themselves are not contained within the card or package. The user may then select system personalization options for the pre-configured system in step 826. In various embodiments, the system personalization options may be physically represented as images and text on a card or a package.

The digital assets product identifier (ID) may then be scanned from its corresponding physical representation in step 828, followed by scanning its corresponding digital assets activation key or other entitlement data in step 830. Data related to the previously selected personalization options may then be likewise scanned in step 832, followed by determining the unique system identifier of the pre-configured system in step 834. In various embodiments, the digital assets product ID, its associated activation key or entitlement data, the personalization option data, and the unique system identifier are represented by a bar code or other indicia on a card or physical package. In various other embodiments, the digital assets product ID, its associated activation key or entitlement data, the personalization option data, and the unique system identifier are contained in a radio frequency identifier (RFID) tag affixed to the physical representation of the digital asset. Those of skill in the art will realize that many such embodiments are possible and that the foregoing is not intended to limit the spirit, scope, or intent of the invention.

Once the system personalization data has been provided in step 820, or the unique system identifier has been determined in step 834, a purchase transaction for the custom-configured or pre-configured target system and any associated digital assets and personalization options may be completed in step 836. Digital asset entitlement operations, as described in greater detail herein, may then be performed by a digital assets entitlement system in step 838 to bind the digital assets, the personalization options, and their respective digital assets entitlement data to the unique system identifier of the target system. The resulting bound data, including data associated with the digital assets (e.g., installation files, etc.) may then be stored in the digital assets entitlement system in step 840 and the custom-configured or pre-configured system may then be delivered to the user in step 842.

Standard operating system (OS) out-of-the-box-experience (DOBE) or hypervisor boot operations may be performed on the new target system in step 844, followed by loading a personalization agent on the target system in step 846. In various embodiments, the personalization agent may have a unique identifier that is associated with one or more unique system component identifiers. In some embodiments, the unique identifier of the personalization agent may be uniquely associated with the current unique system identifier associated with the target system. In other embodiments, a portion of the personalization agent may be delivered to the target system in an encrypted form and is then decrypted prior to being loaded on the target system. In these embodiments, the primary system identifier (e.g., service tag number, serial number, etc.), is used as a decryption key to decrypt the personalization agent.

In various other embodiments, secondary system identifiers may be stored on the target system (e.g., in the BIOS, in Flash memory, on a hard disk, etc.) as well as in the digital assets entitlement system. In these and other embodiments, the digital assets entitlement system may use the secondary system identifiers to encrypt a portion of the personalization agent before it is downloaded to the target system. Once downloaded, the unencrypted portion of the personalization agent may use the secondary system identifiers stored on the target system to decrypt the encrypted portion of the personalization agent. In some embodiments, the secondary system identifiers may likewise be encrypted and may first be decrypted before they are used to decrypt the encrypted portion of the personalization agent. In other embodiments, the secondary system identifiers may be stored in a Trusted Platform Module (TPM). In yet another embodiment, primary system identifiers may be stored in a TPM. Skilled practitioners of the art may recognize that many such embodiments are possible and the foregoing is not intended to limit the spirit, scope, or intent of the invention.

The personalization agent may then query the target system for its unique system identifier in step 848. In various embodiments, the unique system identifier associated with the target system may be stored in the target system's BIOS, flash memory, a hard disk, or other memory device. The personalization agent may then automatically establish a connection with the digital assets entitlement system in step 850 and use the unique system identifier to authenticate the system. Then, in step 852, the unique system identifier may be used by the personalization agent in an electronic interchange with a digital assets entitlement system to determine entitled digital assets and personalization options corresponding to the unique system identifier.

Once determined, the corresponding personalization options and digital assets, along with their associated digital assets entitlement data, may be downloaded in step 854 to the target system. In some embodiments, the personalization options and digital assets, along with their associated digital assets entitlement data, may be downloaded from a single server on a network. In other embodiments, the personalization options and digital assets may be downloaded from one or more servers on a network. In yet other embodiments, the personalization options, digital assets, and associated digital assets entitlement data may be respectively downloaded from a plurality of servers on a network. In these and other embodiments, the digital assets entitlement system may manage the respective location of the personalization options, digital assets, and associated digital assets entitlement data to initiate its provision. Once downloaded, the personalization agent may use the digital assets entitlement data in step 856 to install the digital assets and personalization options on the target system.

A determination may then be made in step 858 whether to perform an after-point-of-sale (APOS) purchase of digital assets. If it is determined in step 858 to not perform an APOS purchase of digital assets, then a determination is made in step 884 whether to continue digital assets entitlement and system personalization operations. If so, then the process may continue, proceeding with step 856. Otherwise, digital assets entitlement and system personalization operations may be ended in step 886.

However, if it is determined in step 858 to perform an APOS purchase of digital assets, then a determination is made in step 860 whether the APOS purchase will be performed in an online or physical environment. If it is determined in step 860 that the APOS purchase is to be performed in an online environment, then the user may select digital assets in step 862 to purchase online. The user then may likewise select any personalization options to purchase online in step 864. The personalization agent may then determine the unique system identifier of the target system in step 874, followed by performing an APOS purchase transaction in step 876 for the purchase of the digital assets and personalization options.

Digital asset entitlement operations, as described in greater detail herein, may then performed by the digital assets entitlement system in step 880 to bind the digital assets, the personalization options, and their respective digital assets entitlement data associated with the APOS purchase to the unique system identifier of the target system. The resulting bound data, including data associated with the digital assets (e.g., installation files, etc.) may then be stored in the digital assets entitlement system in step 882. The process may then continue, proceeding with step 848.

However, if it was determined in step 860 that the APOS purchase is to be performed in a physical environment, then the user may select a physical representation of digital assets to be purchased in step 866. The digital assets product identifier (ID) may then be scanned from its corresponding physical representation in step 868, followed by scanning its corresponding digital assets activation key or other entitlement data in step 870. The user may then select system personalization options, which are likewise scanned in step 872. The process may then be continued, proceeding with step 874.

Although FIGS. 8A-D disclose a particular number of steps to be taken with respect to method 800, method 800 may be executed with greater or lesser steps than those depicted in FIGS. 8A-D. In addition, although FIGS. 8A-D disclose a certain order of steps to be taken with respect to method 800, the steps comprising method 800 may be completed in any suitable order.

Method 800 may be implemented using information handling system 100, system 200, components thereof, and/or any other system operable to implement method 800. In certain embodiments, method 800 may be implemented partially or fully in software and/or firmware embodied in computer-readable media.

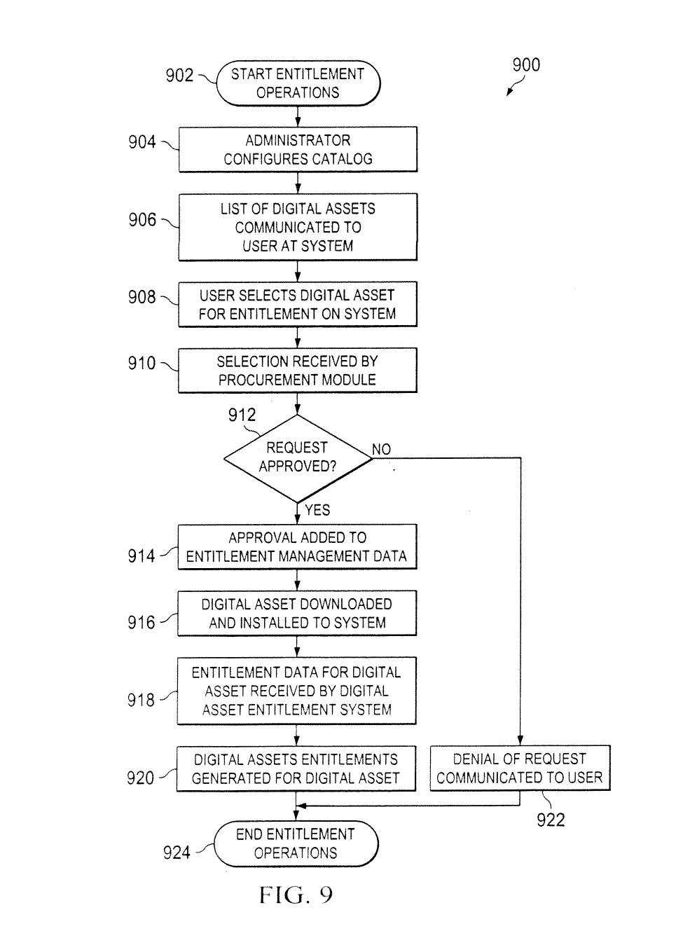

FIG. 9 illustrates a flow chart of an example method for performance of digital assets entitlement with respect to ad hoc digital asset acquisition, in accordance with embodiments of the present disclosure. According to certain embodiments, method 900 may begin at step 902. As noted above, teachings of the present disclosure may be implemented in a variety of configurations of system 200. As such, the preferred initialization point for method 900 and the order of the steps 902-924 comprising method 900 may depend on the implementation chosen.

In method 900, digital assets entitlement operations may begin in step 902. At step 904, an enterprise digital asset management system may receive enterprise administrator configurations for a catalog. For example, the enterprise digital asset management system may be configured such that the enterprise administrator can interface with the enterprise digital asset management system to populate a catalog with the identities of various digital assets for which users within the enterprise may submit requests to have the digital assets entitled for use on systems associated with the users.

At step 906, the enterprise digital asset management system (e.g., via a procurement module) may communicate to a user at a system the identities of one or more digital assets in the catalog. In some embodiments, the identities of all digital assets in the catalog may be communicated. In other embodiments, a subset of the identities of the digital assets in the catalog may be communicated. For example, the identities of digital assets communicated to the system may be filtered based on a property associated with the system or a user thereof (e.g., department, geographical location, etc.).

At step 908, the user may select a particular digital asset that the user desires to be entitled for use on the system. At step 910, the user selection may be received by the procurement module of the enterprise digital asset management system.

At step 912, upon receipt of the user selection, the procurement module may query an administrator for approval of the user request for the digital asset to be entitled for use on the system. If the user request for the digital asset to be entitled for use on the system is approved method 900 may proceed to step 914. Otherwise, if the request is not approved, method 900 may proceed to step 922.

At step 914, in response to an administrator approval for the digital asset to be entitled for use on the requesting user's system, the enterprise digital asset management system may add data regarding the approval to entitlement management data associated with the enterprise, to signify that the system is approved for use of the digital asset. At step 916, the digital asset may be downloaded and installed to the user system. In some instances, the digital asset may be downloaded to the enterprise management system in response to a request by the enterprise digital asset management system to a vendor (e.g., an APOS vendor, a digital assets vendor, etc.), and then subsequently downloaded from the enterprise digital asset management system to the vendor. In other instances, the digital asset may be downloaded to the user's system in response to a request by the enterprise digital asset management to a vendor (e.g., an APOS vendor, a digital assets vendor, etc.). In these and other instances, the digital asset may already be present at the enterprise digital asset management system due to a previous download of the digital asset, and in such a scenario, may be downloaded from the enterprise digital asset management system to the user's system.

At step 918, entitlement data for the digital asset may be received from a vendor (e.g., an APOS vendor, a digital assets vendor, etc.) by the digital asset entitlement system and stored as part of entitlement data 214.

At step 920, digital asset entitlement operations, as described in greater detail herein, may be performed by the digital assets entitlement system to bind the requested digital asset, the personalization options, and their respective digital assets entitlement data associated with the request to the unique system identifier of the system. The resulting bound data, including data associated with the digital assets (e.g., installation files, etc.) may be stored in the digital assets entitlement system.

At step 922, in response to an administrator denial of a user request for entitlement of a digital asset, the denial may be communicated to the user (e.g., via an automated email message, automated alert, etc.) from the enterprise digital asset management system.

At step 924, digital asset entitlement operations may end.

Although FIG. 9 discloses a particular number of steps to be taken with respect to method 900, method 900 may be executed with greater or lesser steps than those depicted in FIG. 9. In addition, although FIG. 9 discloses a certain order of steps to be taken with respect to method 900, the steps comprising method 900 may be completed in any suitable order.

Method 900 may be implemented using information handling system 100, system 200, components thereof, and/or any other system operable to implement method 900. In certain embodiments, method 900 may be implemented partially or fully in software and/or firmware embodied in computer-readable media.

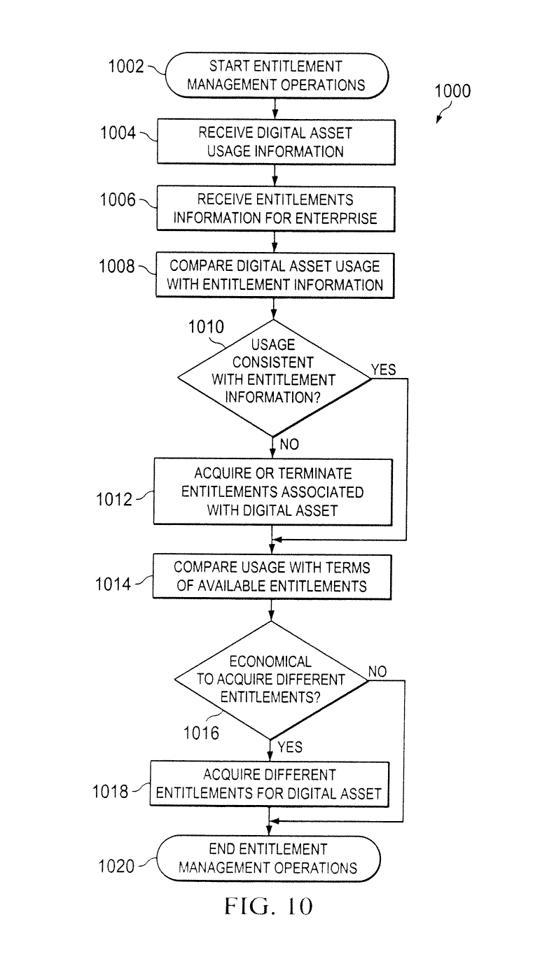

FIG. 10 illustrates a flow chart of an example method 1000 for management digital assets entitlement, in accordance with embodiments of the present disclosure. According to certain embodiments, method 1000 may begin at step 1002. As noted above, teachings of the present disclosure may be implemented in a variety of configurations of system 200. As such, the preferred initialization point for method 1000 and the order of the steps 1002-1020 comprising method 1000 may depend on the implementation chosen.

In method 1000, digital assets entitlement management operations may begin in step 1002. At step 1004, an enterprise digital asset management system may receive digital asset usage information regarding the usage of digital assets in an enterprise. Such information may be received from systems 204 integral to the enterprise and/or virtualization servers integral to the enterprise.

At step 1006, the enterprise digital asset management system may receive entitlement information for the various digital assets of the enterprise. In some embodiments, such information may be communicated from a digital assets entitlement system such as described herein.

At step 1008, the enterprise digital asset management system may compare the digital assets usage information with the entitlement information. At step 1010, the enterprise digital asset management system may determine if the usage information is consistent with the entitlement information. The term “consistent” used in this context means that the usage for a particular digital asset does not exceed the usage allowable by the terms of the entitlements for the digital asset and/or that the usage is not more than a certain pre-defined tolerance below (e.g., 10%) the usage allowable by the terms of the entitlements for the digital asset. If usage for a particular digital asset is inconsistent with the associated entitlements, method 1000 may proceed to step 1012. Otherwise, if usage is inconsistent with the associated entitlements, method 1000 may proceed to step 1014.

At step 1012, in response to a determination that the usage of a digital asset is inconsistent with its associated entitlements, the enterprise digital asset management system may acquire additional entitlements for the digital asset when usage has exceeded the terms of the existing entitlements or may terminate one or more entitlements for the digital asset when usage is significantly less than the usage allowable by the terms of the entitlements for the digital asset.

At step 1014, the enterprise digital asset management system may compare usage information for each of various digital assets to the terms of available entitlements (e.g., available software license terms) for the digital asset. Information regarding the available entitlements may be received from any suitable source (e.g., from a vendor, within the entitlements information, etc.). As a result, at step 1016, the enterprise digital asset management system may determine if it is economically more efficient to acquire different entitlements for the digital asset. For example, analysis may indicate that usage of a digital asset may be such that the enterprise is eligible for a different type of entitlement for the digital asset that may be more cost-efficient than the present entitlement (e.g., usage has increased to where a high-volume license is available). As another example, analysis may indicate that usage of a digital asset may be such that it may be more cost-efficient to downgrade a license (e.g., the enterprise has an enterprise-wide license, but the digital asset is used so sparingly that an entitlement allowing for usage of a small number of copies of the digital asset is more economical). As a further example, available entitlements may change (e.g., a software publisher may provide new or alternative licensing terms), and analysis of usage with such new entitlement terms may be made to determine whether it is beneficial to acquire a different entitlement for a particular digital asset. If it is more economical to acquire different entitlement for the digital asset, method 1000 may proceed to step 1018. Otherwise, method 1000 may proceed to step 1020.

At step 1018, in response to a determination that it is more economical to acquire a different entitlement for the digital asset, the enterprise digital assets management system may initiate the acquisition of different entitlements for the digital asset, and digital asset entitlement operations may be carried out as described in this disclosure.

At 1020, the digital asset entitlement management operations may end.

Although FIG. 10 discloses a particular number of steps to be taken with respect to method 1000, method 1000 may be executed with greater or lesser steps than those depicted in FIG. 10. In addition, although FIG. 10 discloses a certain order of steps to be taken with respect to method 1000, the steps comprising method 1000 may be completed in any suitable order.

Method 1000 may be implemented using information handling system 100, system 200, components thereof, and/or any other system operable to implement method 1000. In certain embodiments, method 1000 may be implemented partially or fully in software and/or firmware embodied in computer-readable media.

The present disclosure is well adapted to attain the advantages mentioned as well as others inherent therein. While the present disclosure has been depicted, described, and is defined by reference to particular embodiments of the disclosure, such references do not imply a limitation on the disclosure, and no such limitation is to be inferred. The disclosure is capable of considerable modification, alteration, and equivalents in form and function, as will occur to those ordinarily skilled in the pertinent arts. The depicted and described embodiments are examples only, and are not exhaustive of the scope of the disclosure.

For example, the above-discussed embodiments include software modules that perform certain tasks. The software modules discussed herein may include script, batch, or other executable files. The software modules may be stored on a machine-readable or computer-readable storage medium such as, for example, a disk drive. Storage devices used for storing software modules in accordance with embodiments of the disclosure may be magnetic floppy disks, hard disks, or optical discs such as CD-ROMs or CD-Rs, for example. A storage device used for storing firmware or hardware modules in accordance with embodiments of the disclosure may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Accordingly, although the present disclosure has been described in detail, it should be understood that various changes, substitutions, and alterations can be made hereto without departing from the spirit and the scope of the disclosure as defined by the appended claims.

1. An information handling system for managing the entitlement of digital assets, comprising:
a storage medium; and
a processor configured to:
receive digital asset usage information regarding usage of a digital asset within an enterprise;
receive entitlement information regarding existing entitlements for usage of the digital asset within the enterprise;
receive available entitlement information regarding entitlements other than the existing entitlements that may be acquired for usage of the digital asset within the enterprise;
determine based on a comparison of the digital asset usage information to the available entitlement information, whether acquisition of entitlements other than the existing entitlements is more cost efficient; and
responsive to a determination that the acquisition of entitlements is more cost efficient, acquire entitlements other than the existing entitlements.

2. The information handling system of claim 1, the processor further operable to acquire entitlements other than the existing entitlements wherein acquiring entitlements includes adding entitlements to a digital asset entitlements record.

3. The information handling system of claim 1, the processor further operable to determine based on a comparison of the digital asset usage information to the entitlement information whether usage of the digital asset is consistent with the entitlement information.

4. The information handling system of claim 3, the processor further configured to acquire one or more additional entitlements for the digital asset responsive to determining that usage of the digital asset is inconsistent with the entitlement information.

5. The information handling system of claim 3, the processor further configured to terminate one or more entitlements for the digital asset responsive to determining that usage of the digital asset is inconsistent with the entitlement information.

6. The information handling system of claim 3, wherein determining whether usage of the digital asset is consistent with the entitlement information comprises determining:
whether usage of the digital asset exceeds the usage allowable by the terms of the existing entitlements; and
whether the usage of the digital asset is more than a certain pre-defined tolerance below the usage allowable by the terms of the existing entitlements.

7. A computer-implemented method for managing the entitlement of digital assets by an entitlement tracking engine in an enterprise digital asset management system, comprising:
receiving digital asset usage information regarding usage of a digital asset within an enterprise;
receiving entitlement information regarding existing entitlements for usage of the digital asset within the enterprise;
receiving available entitlement information regarding entitlements other than the existing entitlements that may be acquired for usage of the digital asset within the enterprise;
determining based on a comparison of the digital asset usage information to the available entitlement information, whether acquisition of entitlements other than the existing entitlements is more cost efficient;
responsive to a determination that the acquisition of entitlements is more cost efficient, acquiring entitlements other than the existing entitlements.

8. The method of claim 7, wherein acquiring entitlements other than the existing entitlements includes adding entitlements to a digital asset entitlements record.

9. The method of claim 7, further comprising determining based on a comparison of the digital asset usage information to the entitlement information whether usage of the digital asset is consistent with the entitlement information.

10. The method of claim 9, further comprising acquiring one or more additional entitlements for the digital asset responsive to determining that usage of the digital asset is inconsistent with the entitlement information.

11. The method of claim 9, further comprising terminating one or more entitlements for the digital asset responsive to determining that usage of the digital asset is inconsistent with the entitlement information.

12. The method of claim 9, wherein determining whether usage of the digital asset is consistent with the entitlement information comprises determining:
whether usage of the digital asset exceeds the usage allowable by the terms of the existing entitlements; and
whether the usage of the digital asset is more than a certain pre-defined tolerance below the usage allowable by the terms of the existing entitlements.

13. An article of manufacture comprising:
a computer readable medium; and
computer-executable instructions stored on the computer readable medium, the instructions readable by a processor, the instructions, when read and executed by the processor, for causing the processor to:
receive digital asset usage information regarding usage of a digital asset within an enterprise;
receive entitlement information regarding existing entitlements for usage of the digital asset within the enterprise;
receive available entitlement information regarding entitlements other than the existing entitlements that may be acquired for usage of the digital asset within the enterprise;
determine based on a comparison of the digital asset usage information to the available entitlement information, whether acquisition of entitlements other than the existing entitlements is more cost efficient; and
responsive to a determination that the acquisition of entitlements is more cost efficient, acquire entitlements other than the existing entitlements.

14. The article of claim 13, the instructions for further causing the processor to acquire entitlements other than the existing entitlements wherein acquiring entitlements includes adding entitlements to a digital asset entitlements record.

15. The article of claim 13, the instructions for further causing the processor to determine based on a comparison of the digital asset usage information to the entitlement information whether usage of the digital asset is consistent with the entitlement information.

16. The article of claim 15, the instructions for further causing the processor to acquire one or more additional entitlements for the digital asset responsive to determining that usage of the digital asset is inconsistent with the entitlement information.

17. The article of claim 15, the instructions for further causing the processor to terminate one or more entitlements for the digital asset responsive to determining that usage of the digital asset is inconsistent with the entitlement information.

18. The article of claim 15, wherein determining whether usage of the digital asset is consistent with the entitlement information comprises determining:
whether usage of the digital asset exceeds the usage allowable by the terms of the existing entitlements; and
whether the usage of the digital asset is more than a certain pre-defined tolerance below the usage allowable by the terms of the existing entitlements.
